(19) United States
(12) Patent Application Publication
(10) Pub. No.: US 2014/0284069 A1
(43) Pub. Date: Sep. 25, 2014

(54) ROW MAKING TOOL

(71) Applicant: ADALBERTO RAMIREZ, JR., LYFORD, TX (US)

(72) Inventor: ADALBERTO RAMIREZ, JR., LYFORD, TX (US)

(21) Appl. No.: 14/138,693

(22) Filed: Dec. 23, 2013

Related U.S. Application Data
(60) Provisional application No. 61/716,972, filed on Oct. 22, 2012.

(51) Int. Cl. A01B 1/10

(52) U.S. Cl. CPC A01B 1/10
USPC 172/378

(57) ABSTRACT

A row making tool is configured to create rows in a home garden that look and function like farm rows. The row making tool has a rail mechanically coupled to a rail shaft. A handle is connected to the rail shaft; wherein the handle is configured to be held and maneuvered with a human hand. A first blade and a second blade and a third blade and a fourth blade are connected to the rail. The first blade and the second blade and a third blade and a fourth blade are configured to create evenly spaced rows in tilled soil of a garden plot in order to prepare the garden for seeding.

### RELATED APPLICATION

This application claims priority to provisional patent application U.S. Ser. No. 61/716,972 filed on Oct. 22, 2012, the entire contents of which is herein incorporated by reference.

### BACKGROUND

The embodiments herein relate generally to hand tools.

Prior to embodiments of the disclosed invention, making garden rows in a garden to prepare it for planting was a difficult, labor intensive, and a slow process. There were no hand tools or machine tools in existence that could create a scaled down version of evenly spaced garden rows that look and function like typical the farm rows, for planting and growing vegetables in home gardens. Embodiments of the disclosed invention solve this problem.

### SUMMARY

A row making tool is configured to quickly make deep evenly spaced garden rows in a tilled garden plot. The row making tool has a rail mechanically coupled to a rail shaft. A handle is connected to the rail shaft; wherein the handle is configured to be held and maneuvered with a human hand. A first blade and a second blade connected to the rail. The first blade and the second blade are configured to create rows in tilled soil in order to prepare the tilled garden plot for planting.

In some embodiments, a third blade and a fourth blade are connected to the rail. The third blade and the fourth blade are configured to create rows in tilled soil in order to prepare the garden plot for planting. The first blade, the second blade, the third blade and the fourth blade can be configured as a quadrilateral with no equal sides and no parallel sides.

The rail shaft can be connected to the handle with a handle shaft extension in order to increase a distance between the rail and the handle. The handle can be connected to the handle shaft extension with an upper pin and an upper retaining pin. The handle shaft extension is attached to the rail shaft with a lower pin and a lower retaining pin. The handle shaft extension can be a hollow tube and the rail shaft can also be a hollow tube. The rail shaft is centered on a balanced weight distribution of the rail, the blades and the weight support rods establish a center point for pull on the center of gravity

In some embodiments, a first weight support rod and a second weight support rod can be connected to the rail. The first rod can be immediately adjacent to a first weight and the second rod can be immediately adjacent to a second weight. Increasing mass on the row making tool increases a downward force upon the first blade and the second blade permitting the first blade and the second blade to sink deeper into the tilled ground. Increasing mass on the row making tool increases force upon the first blade and the second blade permitting the first blade and the second blade to cut deeper into the ground.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of an embodiment of the invention shown in use.

FIG. 2 is a front perspective view of an embodiment of the invention.

FIG. 3 is a rear perspective view of an embodiment of the invention.

FIG. 4 is an exploded view of an embodiment of the invention.

### DETAILED DESCRIPTION OF CERTAIN EMBODIMENTS

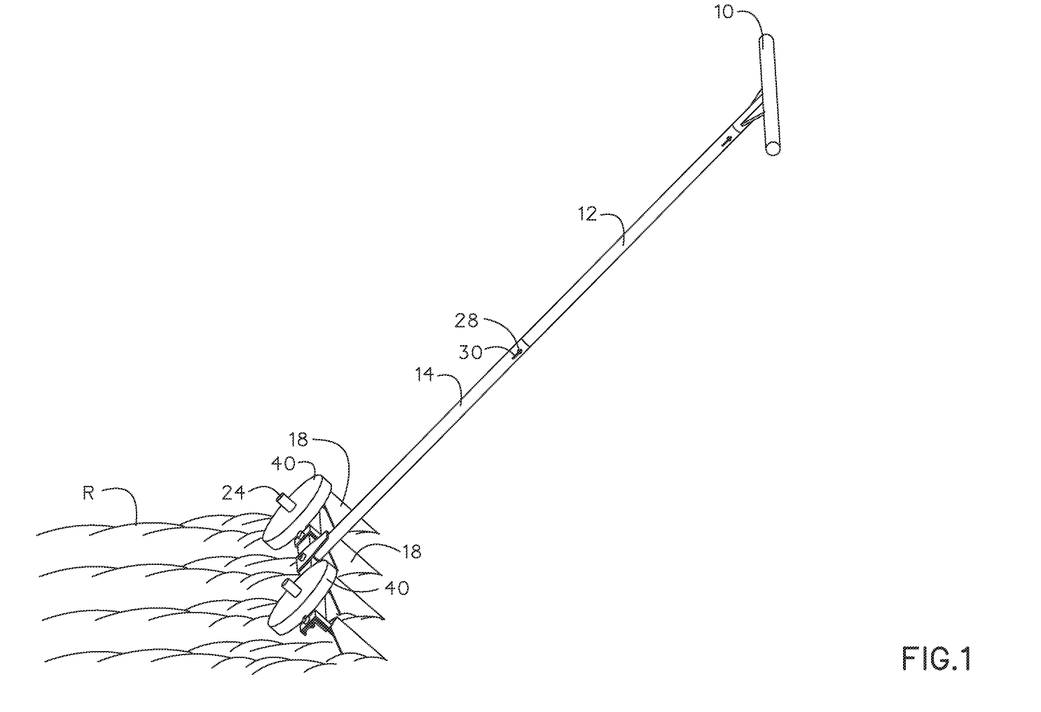

By way of example, and referring to FIG. 1, one embodiment of the row making tool comprises handle 10 detachable coupled to handle shaft extension 12. Handle shaft extension 12 is attached to rail shaft 14. Rail shaft 12 is attached to rail 16. Rail 16 is attached to a plurality of blades 18 where each blade 18 is attached with a bracket 20. Blades 18 are configured to furrow the tilled soil producing garden rows R. Handle 10 is configured to be held and maneuvered with a human hand.

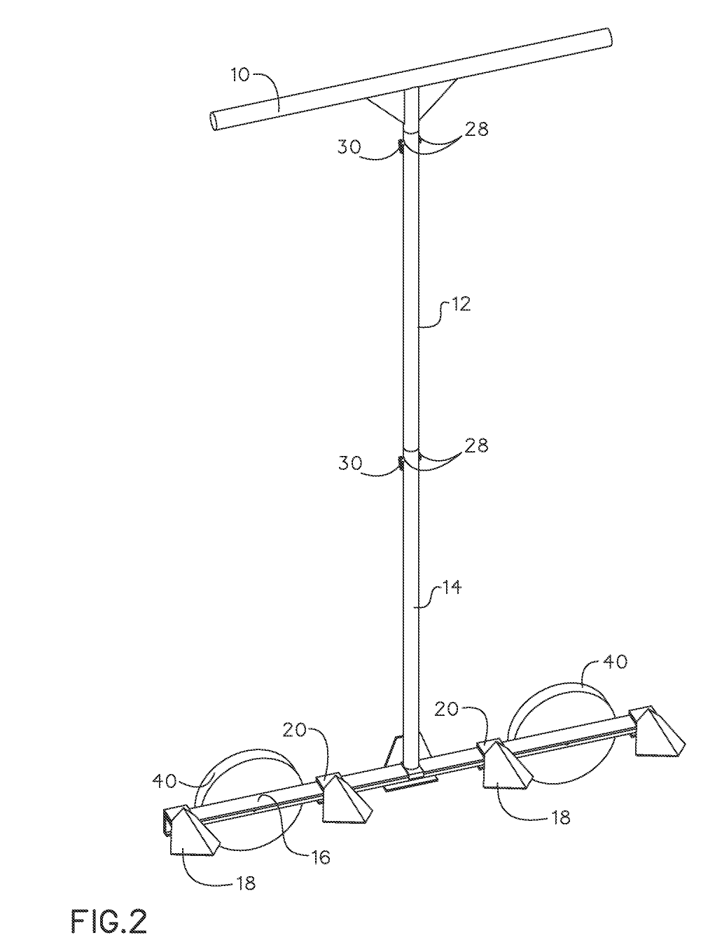

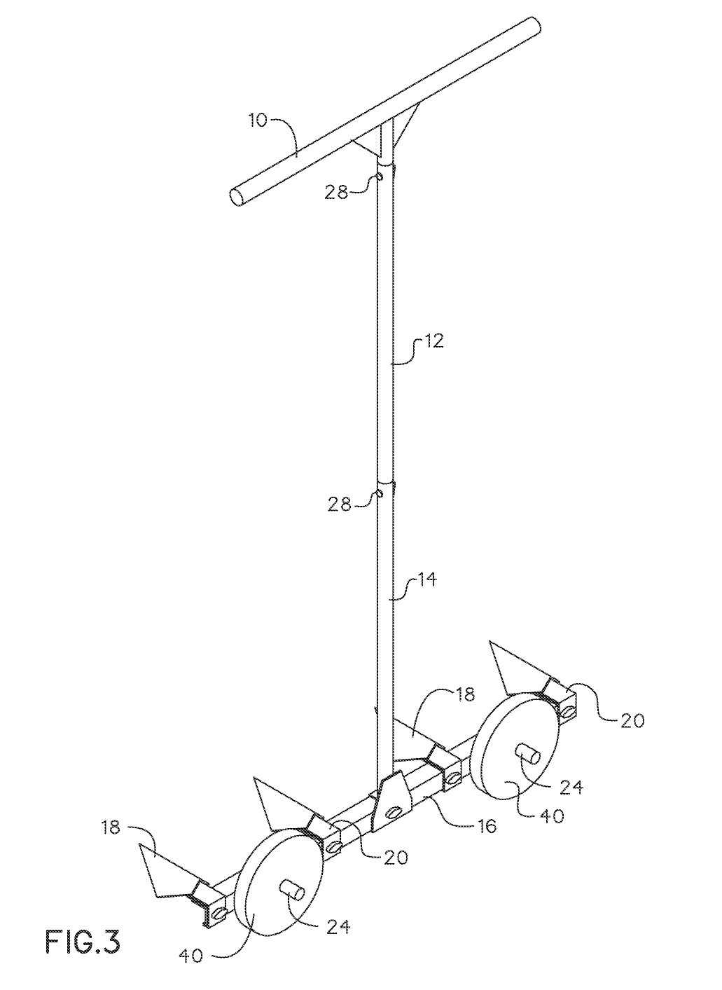

Turning to FIG. 2 and FIG. 3, in some embodiments, the downward force upon blades 18 caused by the weight of the row making tool can be adjusted in, at least, the following ways. First, rail shaft 14 can be a solid cylinder except for a connection point as noted below. Second, handle shaft extension 12 can be made from a hollow tube, which permits a lower center of gravity on the row making tool. Third, rail 16 can be mechanically coupled to rod 24. Rod 24 is configured to accommodate weight 40. Weight 40 can increase weight upon rail 16 and can be of a quantity chosen by the user as a function of the coarseness of the tilled soil to enable blades 18 to furrow deeper into the soil to make garden rows R.

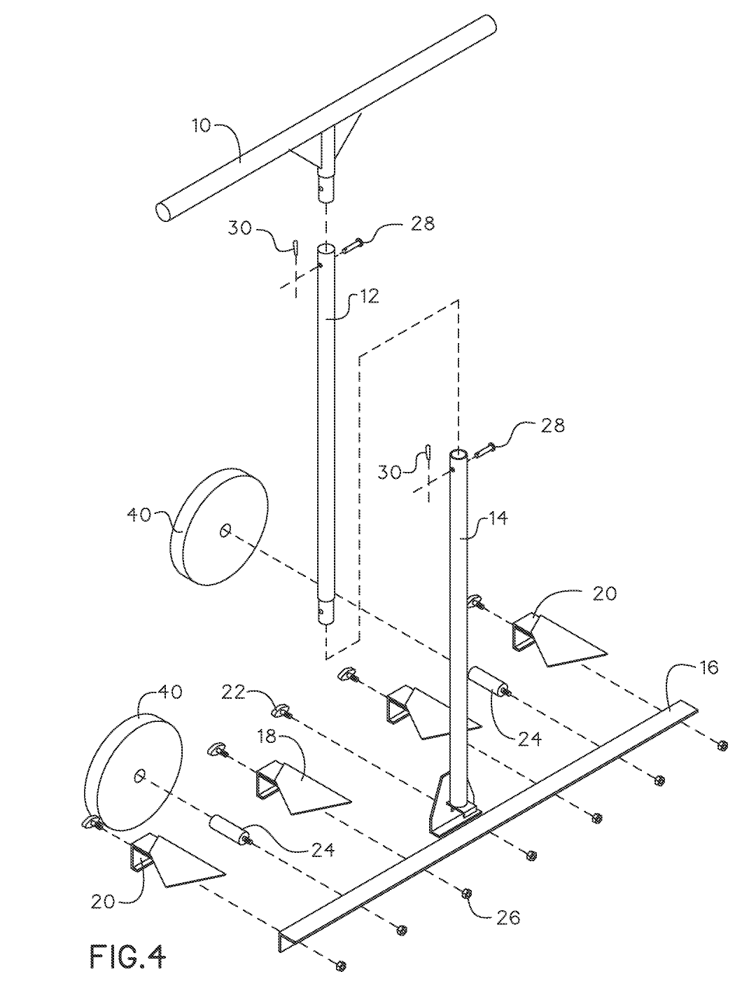

FIG. 4 shows an assembly view of the row making tool. Handle 10 is perforated with an upper handle hole. Handle shaft extension 12 further comprises an upper handle shaft hole. A user can insert upper pin 28 through the upper handle hole and the upper handle shaft hole and then insert upper retaining pin 30 through upper pin 28 to hold upper pin 28 in place.

Handle shaft extension 12 further comprises a lower handle shaft hole. Similarly, rail shaft 14 comprises a rail shaft hole. A user can insert lower pin 28 through the lower handle shaft hole and the rail shaft hole and then insert lower retaining pin 30 through lower pin 28 to hold lower pin 28 in place. Handle shaft extension 12 can increase a distance between rail 16 and handle 10.

It is not necessary to connect handle 10 to rail shaft 14 with handle shaft extension 12. Rather, in some embodiments it may be preferable to omit handle shaft extension 12 altogether and connect handle 10 directly to rail shaft 14. To do this, lower pin 28 is inserted through the upper handle hole and the rail shaft hole and then upper retaining pin 30 is inserted through upper pin 28 to hold upper pin 28 in place.

Rail 16 can be a piece of angle iron. Rail 16 is mechanically coupled to first bracket 20 by screwing first turn screw 22 through rail 16 and then first blade threaded nut 26 onto first turn screw 22. In some embodiments, first blade threaded nut 26 is welded onto rail 16. First bracket 20 is mechanically coupled to first blade 18. First blade 18 can take many shapes, but a quadrilateral with no equal sides and no parallel sides has been found to be effective.

Similarly, rail 16 is mechanically coupled to second bracket 20 by screwing second turn screw 22 through rail 16 and then second blade threaded nut 26 onto second turn screw 22. In some embodiments, second blade threaded nut 26 is welded onto rail 16. Second bracket 20 is mechanically coupled to second blade 18. Second blade 18 can take many shapes, but a quadrilateral with no equal sides and no parallel sides has been found to be effective.

Likewise, rail 16 is mechanically coupled to third bracket 20 by screwing third turn screw 22 through rail 16 and then third blade threaded nut 26 onto third turn screw 22. In some embodiments, third blade threaded nut 26 is welded onto rail 16. Third bracket 20 is mechanically coupled to third blade 18. Third blade 18 can take many shapes, but a quadrilateral with no equal sides and no parallel sides has been found to be effective.

Additionally, rail 16 is mechanically coupled to fourth bracket 20 by screwing fourth turn screw 22 through rail 16 and then fourth blade threaded nut 26 onto fourth turn screw 22. In some embodiments, fourth blade threaded nut 26 is welded onto rail 16. Fourth bracket 20 is mechanically coupled to fourth blade 18. Fourth blade 18 can take many shapes, but a quadrilateral with no equal sides and no parallel sides has been found to be effective.

While four equally spaced blades 18 are disclosed presently, more or fewer blades can be effective in some situations. For instance, a row can be made with any combination of first blade 18, second blade 18, third blade 18 and fourth blade 18 or potentially more blades 18.

Rail 16 is further mechanically coupled to first rod 24. First weight support rod 24 has a first weight support rod threaded portion which is driven through rail 16. The first weight support rod threaded portion is then mechanically coupled to first weight support rod threaded nut 26. In some embodiments, first rod threaded nut 26 is welded onto rail 16. A user can increase a downward force on rail 16 by adding first weight 40 onto first weight support rod 24.

Additionally, rail 16 is further mechanically coupled to second weight support rod 24. Second weight support rod 24 has a second weight support rod threaded portion which is driven through rail 16. The second weight support rod threaded portion is then mechanically coupled to second weight support rod threaded nut 26. In some embodiments, second weight support rod threaded nut 26 is welded onto rail 16. A user can increase a downward force on rail 16 by adding second weight 40 onto second weight support rod 24.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A row making tool, configured to make rows into tilled soil; the row making tool comprising:
a rail mechanically coupled to a rail shaft;
a handle connected to the rail shaft; wherein the handle is configured to be held and maneuvered with a human hand;
a first blade and a second blade connected to the rail;
wherein the first blade and the second blade are configured to cut the rows into the ground in order to prepare the ground for planting.

2. The row making tool of claim 1, further comprising
a third blade and a fourth blade connected to the rail;
wherein the third blade and the fourth blade are configured to cut the rows into the ground in order to prepare the ground for planting.

3. The row making tool of claim 2, wherein the first blade, the second blade, the third blade and the fourth blade are configured as quadrilateral with no equal sides and no parallel sides.

4. The row making tool of claim 2, wherein the rail shaft is connected to the handle with a handle shaft extension in order to increase a distance between the rail and the handle.

5. The row making tool of claim 2, further comprising:
a first weight support rod and a second weight support rod connected to the rail;
wherein the first rod is immediately adjacent to a first weight and the second rod is immediately adjacent to a second weight;
wherein increasing mass on the row making tool increases a downward force equally upon the first blade and the second blade and the third and the fourth blade permitting the first blade and the second blade and the third and the forth blade to sink deeper into the tilled garden soil.

6. The row making tool of claim 4, wherein the handle is connected to the handle shaft extension with an upper pin and an upper retaining pin; wherein the handle shaft extension is attached to the rail shaft with a lower pin and a lower retaining pin.

7. The row making tool of claim 5, wherein the handle shaft extension is a hollow tube and the rail shaft is a hollow tube in order to lower a center of gravity of the row making tool.

8. The row making tool of claim 1, further comprising:
a first weight support rod and a second weight support rod connected to the rail;
wherein the first rod is immediately adjacent to a first weight and the second rod is immediately adjacent to a second weight;
wherein increasing mass on the row making tool increases a downward force equally upon the first blade and the second blade and the third and the fourth blade permitting the first blade and the second blade and the third and the forth blade to sink deeper into the tilled garden soil.
